(19) United States
(12) Patent Application Publication
(10) Pub. No.: US 2018/0285741 A1
(43) Pub. Date: Oct. 4, 2018

(54) COORDINATOR FOR DIGITAL ASSISTANTS

(71) Applicant: Intel Corporation, Santa Clara, CA (US)

(72) Inventors: Carl S. Marshall, Portland, OR (US); Selvakumar Panneer, Hillsboro, OR (US); Ravishankar Iyer, Portland, OR (US)

(21) Appl. No.: 15/476,520

(22) Filed: Mar. 31, 2017

(51) Int. Cl. G06N 5/02; G06F 9/54

(52) U.S. Cl. CPC G06N 5/02; G06F 9/542

(57) ABSTRACT

An embodiment of an electronic processing apparatus may include a user interface to receive an input from a user, an assistant interface to communicate with at least two electronic personal assistants, and a coordinator communicatively coupled to the user interface and the assistant interface. The coordinator may be configured to send a request to one or more of the at least two electronic personal assistants based on the input from the user, collect one or more assistant responses from the one or more electronic personal assistants, and provide a response to the user based on the collected one or more assistant responses. Other embodiments are disclosed and claimed.

### TECHNICAL FIELD

Embodiments generally relate to intelligent personal assistants. More particularly, embodiments relate to a coordinator for digital assistants.

### BACKGROUND

Digital assistants (DAs) such as APPLE's SIRI or AMAZON's ALEXA can respond to user requests by answering queries or performing tasks or services for the user. These tasks or services may be based on the user input, location awareness, and/or the ability to access information from a variety of online sources (such as weather or traffic conditions, news, stock prices, user schedules, retail prices, etc.).

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of a coordinator apparatus according to an embodiment;

FIG. 2 is an illustrative diagram of an example of a table of electronic personal assistant (EPA) versus task according to an embodiment;

FIGS. 3A to 3D are flowcharts of an example of a method of coordinating EPAs according to an embodiment;

FIG. 4 is a block diagram of an example of an EPA according to an embodiment;

FIG. 5 is a block diagram of an example of another coordinator apparatus according to an embodiment;

FIG. 6 is a block diagram of an example of a system including an EPA coordinator according to an embodiment;

FIG. 7 is a block diagram of an example of another system including an EPA coordinator according to an embodiment; and

FIG. 8 is a flowchart of an example of another method of coordinating EPAs according to an embodiment.

### DESCRIPTION OF EMBODIMENTS

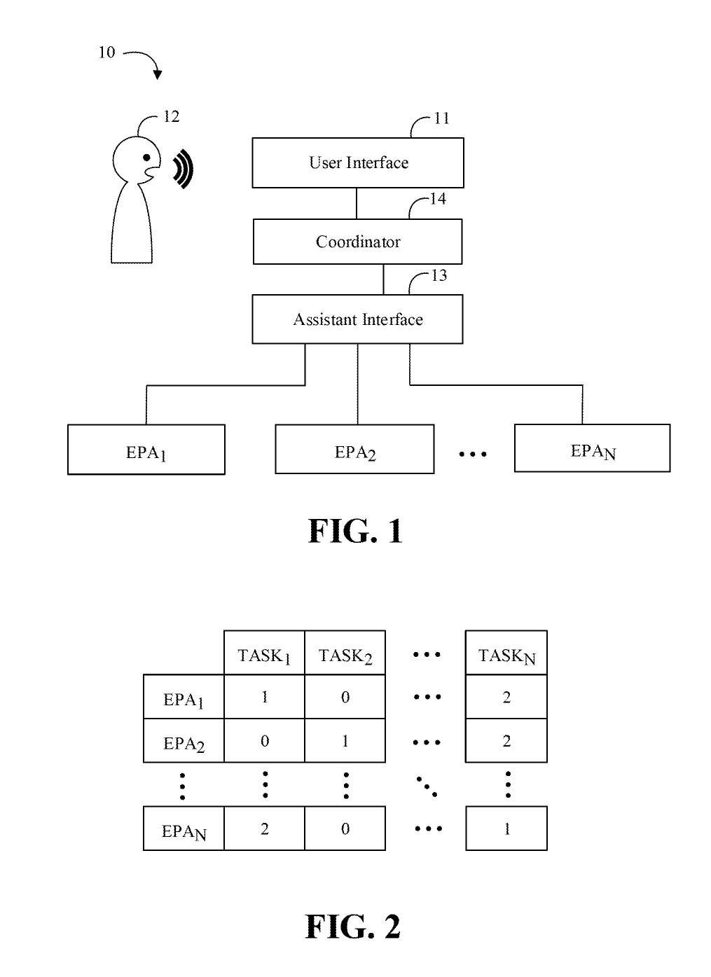

Turning now to FIG. 1, an embodiment of a coordinator apparatus 10 may include a user interface 11 to receive an input from a user 12, an assistant interface 13 to communicate with at least two EPAs (e.g. EPA₁ through EPA_{N}) and a coordinator 14 communicatively coupled to the user interface 11 and the assistant interface 13. In accordance with some embodiments, the coordinator 14 may be configured to send a request to one or more of the at least two EPAs (e.g. any of EPA₁ through EPA_{N}) based on the input from the user 12, collect one or more assistant responses from the one or more EPAs, and provide a response to the user 12 based on the collected one or more assistant responses. In some embodiments of the apparatus 10, the coordinator 14 may be further configured to determine if local information is responsive to the input from the user 12, and provide the response to the user 12 based on the local information if the local information is determined to be responsive to the input from the user 12. The coordinator 14 may also be configured to provide information collected from a first EPA (e.g. EPA₁) to a second EPA (e.g. EPA₂) for the second EPA to learn from the first EPA.

For example, an EPA may include a DA, an intelligent personal assistant, a software agent, an intelligent automated assistant, an intelligent agent, a knowledge navigator, etc. Without being limited to specific features, embodiments of an EPA may include one or more of a capability to organize and maintain information, management of emails and/or text messages, calendar events, files, to-do lists, schedule management (e.g., sending an alert to a dinner date that a user is running late due to traffic conditions, update schedules for both parties, and change the restaurant reservation time), and personal health management (e.g., monitoring caloric intake, heart rate and exercise regimen, then making recommendations for healthy choices), among other capabilities. Examples of DAs include APPLE's SIRI, GOOGLE's GOOGLE HOME, GOOGLE NOW, GOOGLE ASSISTANT, AMAZON ALEXA, AMAZON EVI, MICROSOFT CORTANA, the open source LUCIDA, BRAINA (application developed by BRAINASOFT for MICROSOFT WINDOWS), SAMSUNG's S VOICE, LG G3's VOICE MATE, BLACKBERRY's ASSISTANT, SILVIA, HTC's HIDI, IBM's WATSON, FACEBOOK's M, and ONE VOICE TECHNOLOGIES' IVAN.

In accordance with some embodiments of the apparatus 10, the coordinator 14 may be further configured to send a request to all of the at least two EPAs (e.g. each of EPA₁ through EPA_{N}) based on the input from the user 12, collect assistant responses from all of the at least two EPAs, cross-check the assistant responses, and determine which EPAs were able to accurately translate the user input. For example, the coordinator 14 may also be configured to collect two or more assistant responses, rank the two or more assistant responses based on a context, and provide one of a highest rank assistant response and a rank-ordered list of assistant responses to the user 12. The context may include, for example, a location and/or a category of a request. For example, the user may ask where to get the best Italian food. The coordinator 14 may determine that the context is local restaurants and may rank one assistant response higher based on a profile that indicates that the corresponding EPA is better in the restaurant category. For example, the user may ask to book a flight. The coordinator 14 may determine that the context is travel and may rank one assistant response higher based on a profile that indicates that the corresponding EPA is better with travel arrangements. In some embodiments, the coordinator 14 may also be configured to identify an assistant response selected by the user 12, and learn which EPA was preferred based on the identified user selection.

In some embodiments, the coordinator 14 may be further configured to store one or more categories of information for each of the at least two EPAs, determine a current category based on the user input, compare the current category against the stored one or more categories of information for each EPA, and send a request to one or more of the at least two EPAs based on the comparison. For example, the coordinator 14 may also be configured to collect one or more assistant responses from one or more of the EPAs which indicate a respective confidence level in one or more of the assistant responses, and provide a response to the user 12 based on the respective confidence level.

Embodiments of each of the above user interface 11, assistant interface 13, coordinator 14, and other components of the apparatus 10 may be implemented in hardware, software, or any suitable combination thereof. For example, hardware implementations may include configurable logic such as, for example, programmable logic arrays (PLAs), field programmable gate arrays (FPGAs), complex programmable logic devices (CPLDs), or in fixed-functionality logic hardware using circuit technology such as, for example, application specific integrated circuit (ASIC), complementary metal oxide semiconductor (CMOS) or transistor-transistor logic (TTL) technology, or any combination thereof. Alternatively, or additionally, some operational aspects of these components may be implemented in one or more modules as a set of logic instructions stored in a machine- or computer-readable storage medium such as RAM, read only memory (ROM), programmable ROM (PROM), firmware, flash memory, etc., to be executed by a processor or computing device. For example, computer program code to carry out the operations of the components may be written in any combination of one or more operating system applicable/appropriate programming languages, including an object oriented programming language such as PYTHON, PERL, JAVA, SMALLTALK, C++, C# or the like and conventional procedural programming languages, such as the “C” programming language or similar programming languages.

Turning now to FIG. 2, a table may map available EPAs (e.g. EPA₁ through EPA_{N}) against capabilities and/or preferred tasks for those EPAs (e.g. Task₁ through Task_{N}). For example, tasks may include music-related tasks, calendar or schedule-related tasks, queries, shopping-related tasks, list-related tasks, e-mail-related tasks, text message-related tasks, home management-related tasks, health management-related tasks, etc. For example, a zero (0) in the table may indicate an inability to perform the task (and/or a preference to not use that EPA for that task). For example, a positive integer in the table may indicate a relative priority order of the capability of the EPA to perform the corresponding task (and/or a user-assigned preference for the EPA/task combination). Two entries with the same non-zero value, for example, may indicate no preference by the user between the corresponding EPAs for that task. In some embodiments, the table entries may be entered and maintained completely automatically by the coordinator. In some embodiments, the table entries may be entered and/or updated by the user (e.g. through a configuration or settings interface). In some embodiments, the EPAs may communicate information about their capabilities to the coordinator, which the coordinator may use to update the table.

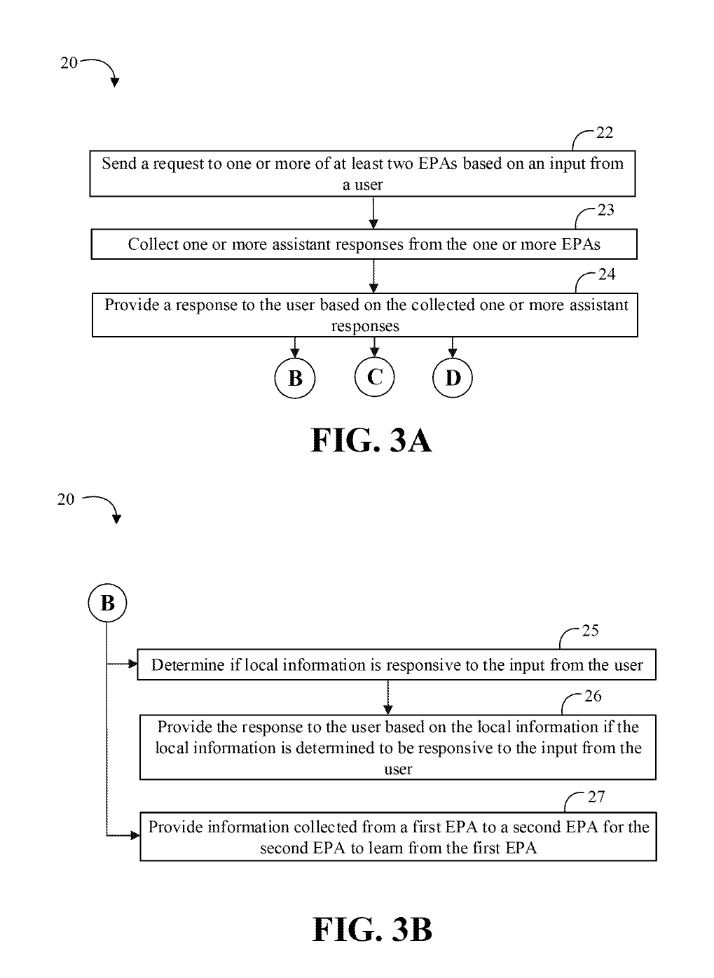

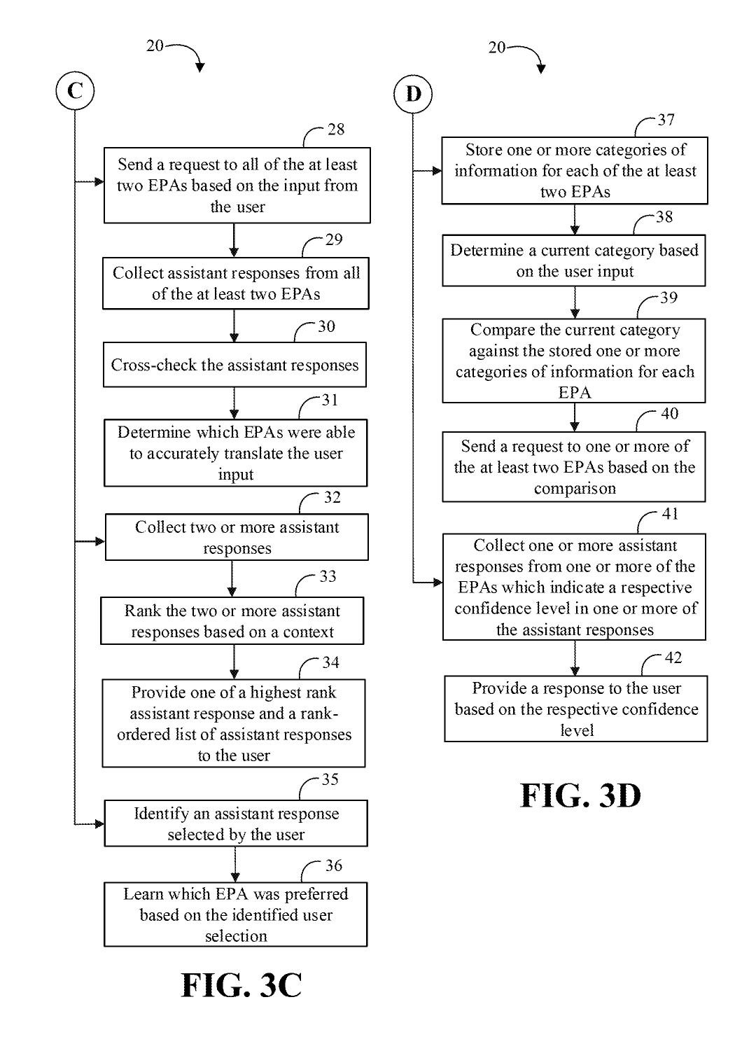

Turning now to FIGS. 3A to 3D, an embodiment of a method 20 of coordinating EPAs may include sending a request to one or more of at least two EPAs based on an input from a user at block 22, receiving one or more assistant responses from the one or more EPAs at block 23, and providing a response to the user based on the collected one or more assistant responses at block 24. For example, the method 20 may further include determining if local information is responsive to the input from the user at block 25, and providing the response to the user based on the local information if the local information is determined to be responsive to the input from the user at block 26. In some embodiments, the method 20 may also include providing information collected from a first EPA to a second EPA for the second EPA to learn from the first EPA at block 27.

In some embodiments, the method 20 may further include sending a request to all of the at least two EPAs based on the input from the user at block 28, receiving assistant responses from all of the at least two EPAs at block 29, cross-checking the assistant responses at block 30, and determining which EPAs were able to accurately translate the user input at block 31. The method 20 may also include receiving two or more assistant responses at block 32, ranking the two or more assistant responses based on a context at block 33, and providing one of a highest rank assistant response and a rank-ordered list of assistant responses to the user at block 34. For example, the method 20 may include identifying an assistant response selected by the user at block 35, and learning which EPA was preferred based on the identified user selection at block 36.

Some embodiments of the method 20 may further include storing one or more categories of information for each of the at least two EPAs at block 37, determining a current category based on the user input at block 38, comparing the current category against the stored one or more categories of information for each EPA at block 39, and sending a request to one or more of the at least two EPAs based on the comparison at block 40. In some embodiments, the method 20 may also include receiving one or more assistant responses from one or more of the EPAs which indicate a respective confidence level in one or more of the assistant responses at block 41, and providing a response to the user based on the respective confidence level at block 42.

Embodiments of the method 20 may be implemented in an electronic processing system or a graphics apparatus such as, for example, those described herein. More particularly, hardware implementations of the method 20 may include configurable logic such as, for example, PLAs, FPGAs, CPLDs, or in fixed-functionality logic hardware using circuit technology such as, for example, ASIC, CMOS, or TTL technology, or any combination thereof. Alternatively, or additionally, the method 20 may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more operating system applicable/appropriate programming languages, including an object oriented programming language such as PYTHON, PERL, JAVA, SMALLTALK, C++ or the like and conventional procedural programming languages, such as the “C” programming language or similar programming languages. For example, embodiments of the method 20 may be implemented on a computer readable medium as described in connection with Examples 17 to 24 below.

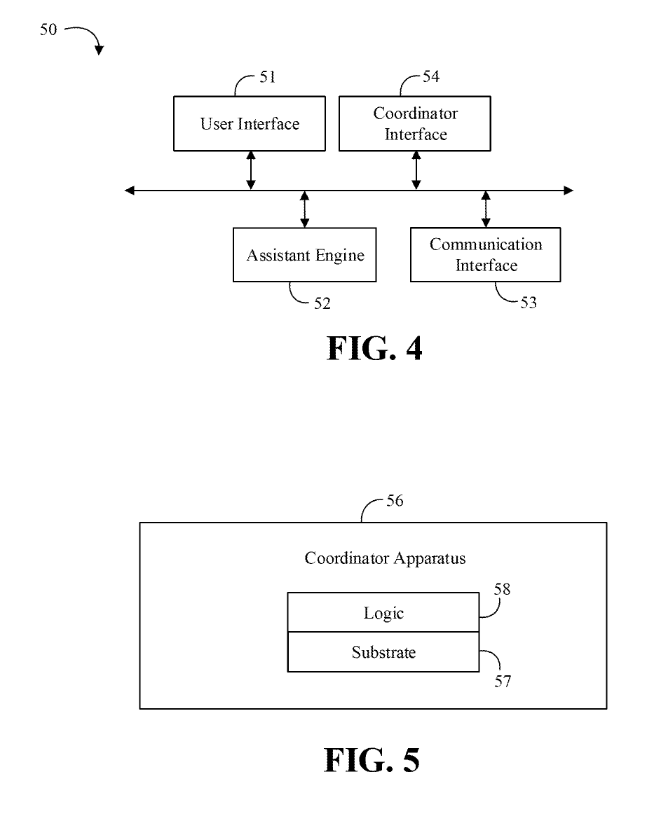

Turning now to FIG. 4, an embodiment of an electronic personal assistant apparatus 50 may include a user interface 51, an assistant engine 52 communicatively coupled to the user interface 51, and a communication interface 53 communicatively coupled to the assistant engine 52. For example, the assistant engine 52 may include the various hardware and software components that provide the capabilities of the EPA (e.g. SIRI running on an IPHONE or other APPLE product, ALEXA running on an ECHO or other AMAZON product, etc.). Advantageously, the apparatus 50 may further include a coordinator interface 54 communicatively coupled to the assistant engine 52 to interface with an EPA coordinator as described herein. For example, a conventional EPA may not have a coordinator interface 54 and in order to benefit from the coordination features described herein the EPA coordinator may need to communicate with the conventional EPA using that EPA's user interface (e.g. by issuing audio requests to the conventional EPA and processing audio responses). With the coordinator interface 54, the apparatus 50 may communicate directly and electronically with the coordinator (e.g. wired or wirelessly over the communication interface 53) to receive requests from the coordinator and to send responses to the coordinator.

For example, the coordinator may receive an audio input from the user (e.g. at a location away from the apparatus 50 or through another EPA), digitize the audio input, and send the digitized audio input to the assistant engine 52 (e.g. through the coordinator interface 54) for further processing. Alternatively, or in addition, the coordinator may receive an audio input from the user, convert that audio input to text data, and send the text data to the assistant engine 52 for further processing. Alternatively, or in addition, the coordinator may send specific electronic requests, instructions, or commands to the assistant engine 52, based on the user input. For example, the request from the coordinator to the assistant engine 52 may not be word-for-word what the user says or types, but may be a different request determined by the coordinator and based on that user input, the context, local intelligence/information about the user, responses from other EPAs, etc. (e.g. derived from the request, but not the literal request itself). Advantageously, the assistant engine 52 may collect information from the coordinator and/or other EPAs (e.g. through the coordinator interface 54) to add to its own knowledge base, such that the various EPA apparatuses 50 may learn from the coordinator and each other. For example, the coordinator may maintain a user profile and share the profile between EPAs. In addition, or alternatively, if the user has built up a profile on a particular EPA and brings a new EPA into their environment, the profile may be shared with the new EPA to transfer some knowledge to the new DA to jumpstart its understanding of the user. In some embodiments, some incentive may be provided to encourage sharing digital data for the user's benefit.

For example, a user may have preferences in movies, music, restaurants, sports teams, etc., which can be shared (e.g. with the user's permission and/or for the user's benefit). Another EPA may have more personal health info. Another EPA may understand car repair or mechanical repair of parts, etc.

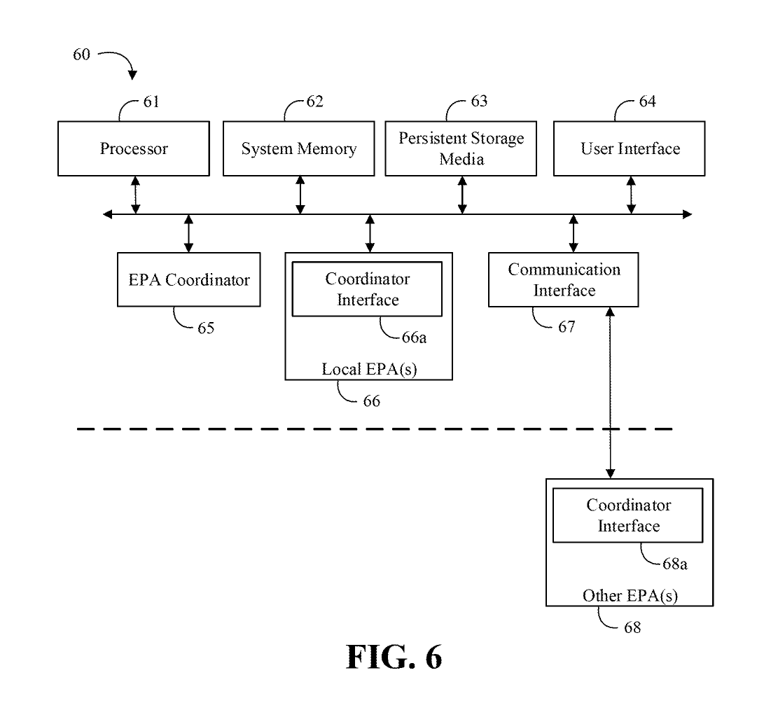

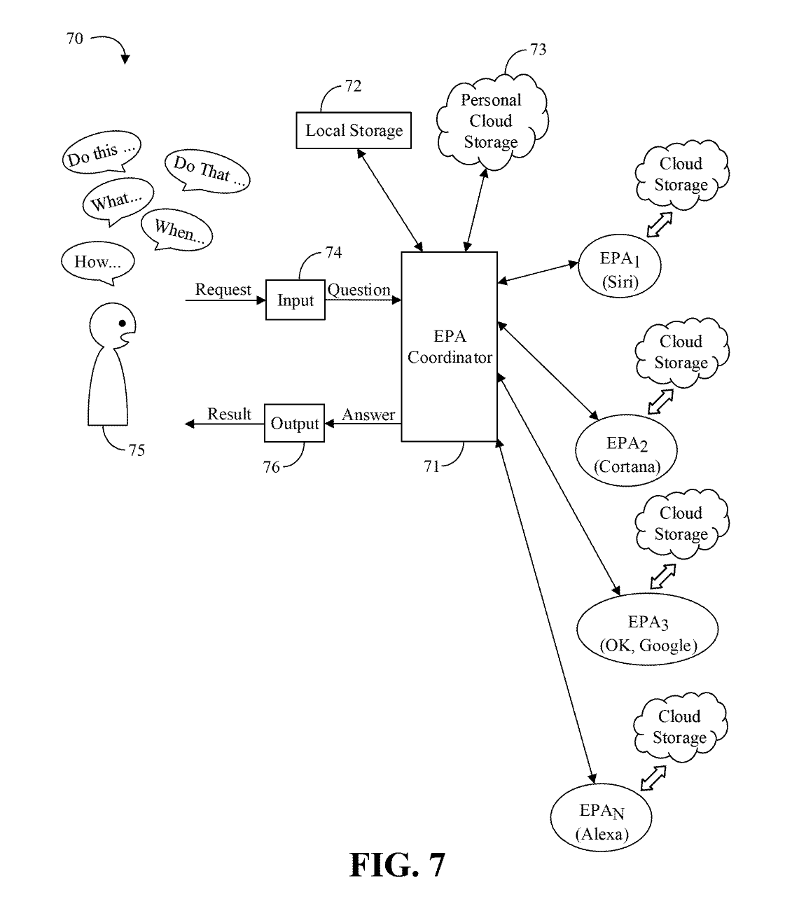

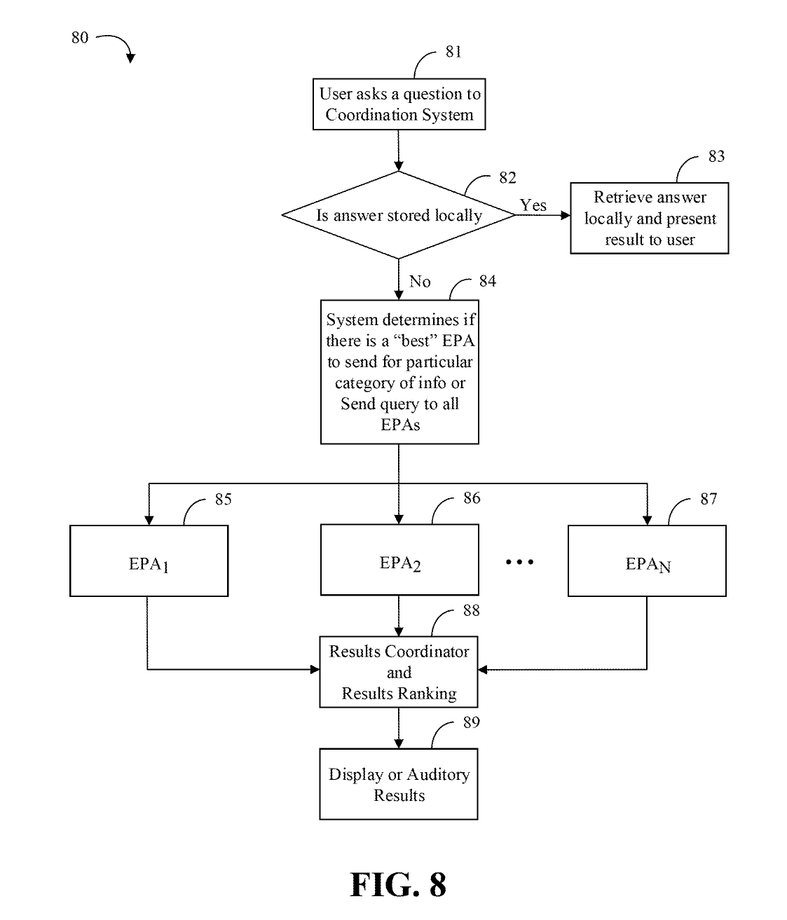

FIG. 5 shows an embodiment of a coordinator apparatus 56. The apparatus 56 may implement one or more aspects of the method 20 (FIGS. 3A to 3D) and/or the method 80 (FIG. 8) and may be readily substituted for the coordinator apparatus 10 (FIG. 1), already discussed, or the EPA coordinator 65 (FIG. 6) or 71 (FIG. 7), discussed below. The illustrated apparatus 56 includes a substrate 57 (e.g., silicon, sapphire, gallium arsenide) and logic 58 (e.g., transistor array and other integrated circuit/IC components) coupled to the substrate 57. The logic 58 may be implemented at least partly in configurable logic or fixed-functionality logic hardware. Moreover, the logic 58 may send a request to one or more of at least two electronic personal assistants based on an input from a user, collect one or more assistant responses from the one or more electronic personal assistants, and provide a response to the user based on the collected one or more assistant responses. The logic 58 may also determine if local information is responsive to the input from the user, and provide the response to the user based on the local information if the local information is determined to be responsive to the input from the user. The logic 58 may also provide information collected from a first electronic personal assistant to a second electronic personal assistants for the second electronic personal assistant to learn from the first electronic personal assistant.

In some embodiments, the logic 58 may also send a request to all of the at least two electronic personal assistants based on the input from the user, collect assistant responses from all of the at least two electronic personal assistants, cross-check the assistant responses, and determine which electronic personal assistants were able to accurately translate the user input. For example, the logic 58 may also collect two or more assistant responses, rank the two or more assistant responses based on a context, and provide one of a highest rank assistant response and a rank-ordered list of assistant responses to the user. The logic 58 may also identify an assistant response selected by the user, and learn which electronic personal assistant was preferred based on the identified user selection. The logic 58 may also store one or more categories of information for each of the at least two electronic personal assistants, determine a current category based on the user input, compare the current category against the stored one or more categories of information for each electronic personal assistant, and send a request to one or more of the at least two electronic personal assistants based on the comparison. For example, the logic 58 may also collect one or more assistant responses from one or more of the electronic personal assistants which indicate a respective confidence level in one or more of the assistant responses, and provide a response to the user based on the respective confidence level.

Turning now to FIG. 6, an embodiment of an electronic processing system 60 may include a processor 61, system memory 62, persistent storage media 63, a user interface 64, an EPA coordinator 65 as described herein, one or more local EPAs 66, and a communication interface 67, all communicatively coupled to each other (e.g. via a bus). The local EPA(s) 66 may each include a coordinator interface 66a to interface with the EPA coordinator 65. For example, the system 60 may be implemented as a smartphone or tablet device with a local EPA 66 to perform functions such as voice-based queries, voice-based schedule management, voice-based email and text management, etc. For example, code to implement these features may be stored in the persistent storage media 63, loaded into the system memory 62, and executed by the processor 61. Advantageously, the persistent storage media 63 may include a set of instructions which when executed by the processor 61 cause the EPA coordinator 65 to implement the method 20 (FIGS. 3A to 3D) and/or the method 80 (FIG. 8) described herein.

The system 60 may further include other EPA(s) 68 communicatively coupled to the system 60 (e.g. wired or wirelessly through the communication interface 67. The other EPAs 68 may each include a coordinator interface 68a to interface with the coordinator 65. For example, the other EPA 68 may include a stand-alone device (e.g. with its own processor and memory) used primarily for voice-based queries and voice-based music management (e.g. based on user preferences and/or the capabilities of the devices). In accordance with an embodiment, a user may make an audio request into their hand-held EPA along the lines of “Play my favorite playlist on my other EPA,” which could be processed by the coordinator and sent to the other EPA as “Play user's favorite playlist,” after which the other EPA processes that request and starts playing the identified playlist. In some embodiments, in an intermediate step the coordinator may send a request to all of the user's available EPAs to determine statistics related to all of the user's playlists. The coordinator may collect those statistics and compare them to determine the user's favorite playlist (and then send the request to the other EPA for playback as “Play <playlist>”).

In accordance with some embodiments, each EPA may have a distinct persona, some specialization, and/or some recognized advantage/benefit as compared to other EPAs. For example, some EPAs may have more of a health care aspect. This aspect may be compared to search engines, where some search engines may be more generic, but some may be better at some queries as opposed to others. With the growth of the INTERNET OF THINGS, numerous devices in a user's location device may provide their own EPA or persona. Advantageously, an EPA coordinator in accordance with some embodiments may coalesce multiple EPAs/personas into to a single entity that the user may interact with. For example, if the user maintains a music library on one cloud service (e.g. native to AMAZON ECHO), but the user maintains their schedule on another service (e.g. native to GOOGLE CALENDAR), the EPA coordinator knows where to direct requests (e.g. music to AMAZON ECHO; calendar to OK, GOOGLE).

In accordance with some embodiments, the coordinator may build and maintain local intelligence. For example, the coordinator may build a database of available EPAs, strengths/weaknesses of each EPA, user preferences with respect to DAs, etc. Advantageously, the local intelligence may reduce latency and may also reduce some privacy/security concerns. For example, with a conventional EPA, every time the user speaks, the EPA goes to the cloud with the voice sample, where it is deciphered and an appropriate response is determined and delivered back to the EPA. By building local intelligence, some queries/requests of the user may be satisfied locally. Advantageously, it may be more efficient if the user request may be answered with local data and the user may be able to keep more information private. If the user asks about something five different times, the answer may be kept locally so the query goes to the cloud only once instead of five separate times. This saves network bandwidth with local processing, and may involve less security/private concerns because the information is kept internally.

Advantageously, some embodiments may provide a self-learning system to coordinate personal electronic assistants. A user may have numerous EPAs (e.g. SIRI, OK GOOGLE, CORTANA, ALEXA, etc.) that may co-exist in the same environment. As EPAs become more common place in today's environments, it may be a problem to know which digital assistant to ask for information on a particular subject (e.g. or to perform a particular task). A user may not know which EPA to pose a particular question to or if one EPA has more information about a topic than another EPA. In an environment of many devices that are all voice-activated, a user may not know how to refer to a particular device. For example, a user may be required to remember a multitude of catch-phrases to activate each EPA or voice-activated device. If multiple devices answer, then a user may not know which one to pick to best answer a query. In accordance with some embodiments, one or more of the foregoing problems are overcome with an EPA coordinator. For example, if a new EPA come online the user may tell the coordinator to get the new EPA up to speed. The new EPA may go into learning mode and the other EPAs could share data with the new EPA about various topics. On some embodiments, each time an EPA answers a question, the coordinator can send the answer to the other EPAs so they can learn from each other.

Turning now to FIG. 7, an EPA system 70 may include an EPA coordinator 71 to coordinate requests and responses among multiple EPAs (e.g. EPA₁ through EPA_{N}) communicatively coupled to the EPA coordinator 71. For example, EPA₁ may include SIRI as a DA, EPA₂ may include CORTANA as a DA, EPA₃ may include OK, GOOGLE as a DA, and EPA_{N} may include ALEXA as a DA. Advantageously, one or more of the EPAs may be adapted with a coordinator interface to directly/electronically exchange information with the EPA coordinator 71. The EPA coordinator 71 may also be communicatively coupled to local storage 72 and/or personal cloud storage 73. Each of the EPAs may also have respective access to cloud storage (e.g. as well as respective local storage). The EPA system 70 may further include an input unit 74 communicatively coupled to the EPA coordinator 71 to receive input from a user 75, and an output unit 76 communicatively coupled to the EPA coordinator 71 to provide output to the user 75. For example, the input unit 74 may include one or more microphones, one or more cameras (e.g. including depth cameras), one or more touch interfaces, and/or other input devices. For example, the output unit 76 may include one or more displays, one or more speakers, one or more haptic devices, and/or other output devices.

In accordance with some embodiments, the user 75 and/or the EPA coordinator 71 may map which general areas of knowledge each EPA has access to (e.g. and prioritize those areas between the available EPAs). Advantageously, the EPA coordinator 71 may then coordinate requested information among multiple EPAs based on that mapping. In some embodiments, the EPAs may learn from each other when they don't have the information that the user is seeking but another EPA does (e.g. and is authorized to share the information). A problem with conventional EPAs is that the user may access them one at a time. If the conventional EPA doesn't know the answer, can't perform the tasks, or otherwise cannot process the request, the conventional EPA may provide a response along the lines of “I do not know this information at this time” or may provide a list of web search results. Advantageously, some embodiments may provide an EPA which is more effective because the EPA coordinator 71 may coordinate with multiple EPAs to query in order to get the best or better results.

In accordance with some embodiments, the EPA system 70 may advantageously act as a coordinator between multiple EPAs to get multiple answers to a query. For example, the EPA system 70 may send the request to all EPAs and cross-check which EPAs were able to translate the input more accurately (e.g. a speech query may be translated into text and then compared across the available EPAs). The EPA system 70 may also rank the answers based on a context of the user 75 and present an ordered list or the best answer (e.g. the highest ranked answer). In some embodiments, the EPA system 70 may learn from the user 75 which answers were considered most relevant by having the user 75 select which result was considered best.

In accordance with some embodiments, the EPA system 70 may store one or more relevant queries locally without having to go to the cloud when the next request is made. If the user 75 makes a request along the lines of “tell me more on a subject,” the EPA system 70 could identify which EPA provided the original information and make a new request to that EPA for information (or expand the request to other EPAs). For example, the EPA system 70 may store which categories of information that one EPA has more knowledge of as compared to other EPAs. On a subsequent query on that category, the EPA system 70 may make a request to that particular EPA. For instance, if one EPA has more knowledge of local events, then the system would make such requests to that particular EPA. In some embodiments, the EPA system 70 may collect a response from the EPA based on the query indicating the EPA's confidence level in answering such a query in a successful manner. For example, the EPA system 70 may use a sampling approach to test answers across multiple EPAs at periodic intervals in order to confirm the EPAs ability from time to time.

In accordance with some embodiments, the EPA system 70 may allow the EPAs to learn from each other. For example, if one EPA doesn't have the correct information or knowledge, then the EPA coordinator 71 may ask the other DAs for the information and provide the information to the one EPA, which may store the information for future requests (e.g. such information may include general knowledge, but may also include user specific information such as preferences/settings/etc.). The EPA system 70 may allow for a request of each EPA, store the results, and then request an EPA to learn the information if the EPA didn't have prior knowledge. In some embodiments, the user 75 may ask the EPA system 70 to learn about a particular subject and the EPA system 70 could start querying all the EPAs to find as much information about the subject that it can. For example, the EPA system 70 may also learn from other systems that other users have setup to reduce access to the cloud and may be more in a trusted circle of users. For example, this approach may also apply to different groups within a company.

In accordance with some embodiments, the EPA system 70 may also coordinate lists on particular EPAs like tasks lists, shopping lists, etc. The EPA system 70 may then keep a synchronized list of all available EPA lists. In some embodiments, the EPA system 70 may be applied to task management of smart devices which may correspond to assistants with tangible form factors (e.g. robots, droids, appliances, etc.). For example, if one device (e.g. a robot) may perform a task faster or better than another device, then the EPA system 70 may choose the device with the best answer (e.g. the fastest estimated completion time returned from a query to the available devices). For example, the user 75 may need to put away dishes, so the EPA system 70 may coordinate among which robots respond that they can do the job. Alternatively, or in addition, the EPA system 70 may break down the tasks and have multiple robots do individual segments of a task.

Turning now to FIG. 8, an embodiment of a method 80 of coordinating multiple EPAs shows one instantiation of how a user may make a request to a coordination system and get results from one or more EPAs. The method 80 may start with the user asking a question to the coordination system at block 81. If the answer is stored locally at block 82, the answer may be retrieved locally and presented to the user at block 83. Otherwise, the system may determine if there is a preferred or best EPA to send the query to (e.g. and send the query to one or more EPAs based on that determination), or send the query to all of the available EPAs at block 84. One or more of EPA₁ (e.g. at block 85), EPA₂ (e.g. at block 86), through EPA_{N} (e.g. at block 87) may respectively process the query and provide their results to the coordination system. The results provided by the EPAs may be coordinated and/or ranked at block 88 and a response may be provided to the user at block 89 (e.g. by display or auditory output).

Additional Notes and Examples:

Example 1 may include a coordinator apparatus, comprising a substrate, and logic coupled to the substrate and implemented at least partly in one or more of configurable logic or fixed-functionality logic hardware, the logic to send a request to one or more of at least two electronic personal assistants based on an input from a user, collect one or more assistant responses from the one or more electronic personal assistants, and provide a response to the user based on the collected one or more assistant responses.

Example 2 may include the apparatus of Example 1, wherein the logic is to determine if local information is responsive to the input from the user, and provide the response to the user based on the local information if the local information is determined to be responsive to the input from the user.

Example 3 may include the apparatus of Example 1, wherein the logic is to provide information collected from a first electronic personal assistant to a second electronic personal assistant for the second electronic personal assistant to learn from the first electronic personal assistant.

Example 4 may include the apparatus of Example 1, wherein the logic is to send a request to all of the at least two electronic personal assistants based on the input from the user, collect assistant responses from all of the at least two electronic personal assistants, cross-check the assistant responses, and determine which electronic personal assistants were able to accurately translate the user input.

Example 5 may include the apparatus of Example 1, wherein the logic is to collect two or more assistant responses, rank the two or more assistant responses based on a context, and provide one of a highest rank assistant response and a rank-ordered list of assistant responses to the user.

Example 6 may include the apparatus of Example 5, wherein the logic is to identify an assistant response selected by the user, and learn which electronic personal assistant was preferred based on the identified user selection.

Example 7 may include the apparatus of any of Examples 1 to 6, wherein the logic is to store one or more categories of information for each of the at least two electronic personal assistants, determine a current category based on the user input, compare the current category against the stored one or more categories of information for each electronic personal assistant, and send a request to one or more of the at least two electronic personal assistants based on the comparison.

Example 8 may include the apparatus of any of Examples 1 to 6, wherein the logic is to collect one or more assistant responses from one or more of the electronic personal assistants which indicate a respective confidence level in one or more of the assistant responses, and provide a response to the user based on the respective confidence level.

Example 9 may include a method of coordinating electronic personal assistants, comprising sending a request to one or more of at least two electronic personal assistants based on an input from a user, receiving one or more assistant responses from the one or more electronic personal assistants, and providing a response to the user based on the collected one or more assistant responses.

Example 10 may include the method of Example 9, further comprising determining if local information is responsive to the input from the user, and providing the response to the user based on the local information if the local information is determined to be responsive to the input from the user.

Example 11 may include the method of Example 9, further comprising providing information collected from a first electronic personal assistant to a second electronic personal assistant for the second electronic personal assistant to learn from the first electronic personal assistant.

Example 12 may include the method of Example 9, further comprising sending a request to all of the at least two electronic personal assistants based on the input from the user, receiving assistant responses from all of the at least two electronic personal assistants, cross-checking the assistant responses, and determining which electronic personal assistants were able to accurately translate the user input.

Example 13 may include the method of Example 9, further comprising receiving two or more assistant responses, ranking the two or more assistant responses based on a context, and providing one of a highest rank assistant response and a rank-ordered list of assistant responses to the user.

Example 14 may include the method of Example 13, further comprising identifying an assistant response selected by the user, and learning which electronic personal assistant was preferred based on the identified user selection.

Example 15 may include the method of any of Examples 9 to 14, further comprising storing one or more categories of information for each of the at least two electronic personal assistants, determining a current category based on the user input, comparing the current category against the stored one or more categories of information for each electronic personal assistant, and sending a request to one or more of the at least two electronic personal assistants based on the comparison.

Example 16 may include the method of any of Examples 9 to 14, further comprising receiving one or more assistant responses from one or more of the electronic personal assistants which indicate a respective confidence level in one or more of the assistant responses, and providing a response to the user based on the respective confidence level.

Example 17 may include at least one computer readable medium, comprising a set of instructions, which when executed by a computing device, cause the computing device to send a request to one or more of at least two electronic personal assistants based on an input from a user, collect one or more assistant responses from the one or more electronic personal assistants, and provide a response to the user based on the collected one or more assistant responses.

Example 18 may include the at least one computer readable medium of Example 17, comprising a further set of instructions, which when executed by the computing device, cause the computing device to determine if local information is responsive to the input from the user, and provide the response to the user based on the local information if the local information is determined to be responsive to the input from the user.

Example 19 may include the at least one computer readable medium of Example 17, comprising a further set of instructions, which when executed by the computing device, cause the computing device to provide information collected from a first electronic personal assistant to a second electronic personal assistant for the second electronic personal assistant to learn from the first electronic personal assistant.

Example 20 may include the at least one computer readable medium of Example 17, comprising a further set of instructions, which when executed by the computing device, cause the computing device to send a request to all of the at least two electronic personal assistants based on the input from the user, collect assistant responses from all of the at least two electronic personal assistants, cross-check the assistant responses, and determine which electronic personal assistants were able to accurately translate the user input.

Example 21 may include the at least one computer readable medium of Example 17, comprising a further set of instructions, which when executed by the computing device, cause the computing device to collect two or more assistant responses, rank the two or more assistant responses based on a context, and provide one of a highest rank assistant response and a rank-ordered list of assistant responses to the user.

Example 22 may include the at least one computer readable medium of Example 21, comprising a further set of instructions, which when executed by the computing device, cause the computing device to identify an assistant response selected by the user, and learn which electronic personal assistant was preferred based on the identified user selection.

Example 23 may include the at least one computer readable medium of any of Examples 17 to 22, comprising a further set of instructions, which when executed by the computing device, cause the computing device to store one or more categories of information for each of the at least two electronic personal assistants, determine a current category based on the user input, compare the current category against the stored one or more categories of information for each electronic personal assistant, and send a request to one or more of the at least two electronic personal assistants based on the comparison.

Example 24 may include the at least one computer readable medium of any of Examples 17 to 22, comprising a further set of instructions, which when executed by the computing device, cause the computing device to collect one or more assistant responses from one or more of the electronic personal assistants which indicate a respective confidence level in one or more of the assistant responses, and provide a response to the user based on the respective confidence level.

Example 25 may include a coordinator apparatus, comprising means for sending a request to one or more of at least two electronic personal assistants based on an input from a user, means for receiving one or more assistant responses from the one or more electronic personal assistants, and means for providing a response to the user based on the collected one or more assistant responses.

Example 26 may include the apparatus of Example 25, further comprising means for determining if local information is responsive to the input from the user, and means for providing the response to the user based on the local information if the local information is determined to be responsive to the input from the user.

Example 27 may include the apparatus of Example 25, further comprising means for providing information collected from a first electronic personal assistant to a second electronic personal assistant for the second electronic personal assistant to learn from the first electronic personal assistant.

Example 28 may include the apparatus of Example 25, further comprising means for sending a request to all of the at least two electronic personal assistants based on the input from the user, means for receiving assistant responses from all of the at least two electronic personal assistants, means for cross-checking the assistant responses, and means for determining which electronic personal assistants were able to accurately translate the user input.

Example 29 may include the apparatus of Example 25, further comprising means for receiving two or more assistant responses, means for ranking the two or more assistant responses based on a context, and means for providing one of a highest rank assistant response and a rank-ordered list of assistant responses to the user.

Example 30 may include the apparatus of Example 29, further comprising means for identifying an assistant response selected by the user, and means for learning which electronic personal assistant was preferred based on the identified user selection.

Example 31 may include the apparatus of any of Examples 25 to 30, further comprising means for storing one or more categories of information for each of the at least two electronic personal assistants, means for determining a current category based on the user input, means for comparing the current category against the stored one or more categories of information for each electronic personal assistant, and means for sending a request to one or more of the at least two electronic personal assistants based on the comparison.

Example 32 may include the apparatus of any of Examples 25 to 30, further comprising means for receiving one or more assistant responses from one or more of the electronic personal assistants which indicate a respective confidence level in one or more of the assistant responses, and means for providing a response to the user based on the respective confidence level.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. An apparatus, comprising:
a substrate; and
logic coupled to the substrate and implemented at least partly in one or more of configurable logic or fixed-functionality logic hardware, the logic to:
send a request to one or more of at least two electronic personal assistants based on an input from a user;
collect one or more assistant responses from the one or more electronic personal assistants; and
provide a response to the user based on the collected one or more assistant responses.

2. The apparatus of claim 1, wherein the logic is to:
determine if local information is responsive to the input from the user; and
provide the response to the user based on the local information if the local information is determined to be responsive to the input from the user.

3. The apparatus of claim 1, wherein the logic is to:
provide information collected from a first electronic personal assistant to a second electronic personal assistant for the second electronic personal assistant to learn from the first electronic personal assistant.

4. The apparatus of claim 1, wherein the logic is to:
send a request to all of the at least two electronic personal assistants based on the input from the user;
collect assistant responses from all of the at least two electronic personal assistants;
cross-check the assistant responses; and
determine which electronic personal assistants were able to accurately translate the user input.

5. The apparatus of claim 1, wherein the logic is to:
collect two or more assistant responses;
rank the two or more assistant responses based on a context; and
provide one of a highest rank assistant response and a rank-ordered list of assistant responses to the user.

6. The apparatus of claim 5, wherein the logic is to:
identify an assistant response selected by the user; and
learn which electronic personal assistant was preferred based on the identified user selection.

7. The apparatus of claim 1, wherein the logic is to:
store one or more categories of information for each of the at least two electronic personal assistants;
determine a current category based on the user input;
compare the current category against the stored one or more categories of information for each electronic personal assistant; and
send a request to one or more of the at least two electronic personal assistants based on the comparison.

8. The apparatus of claim 1, wherein the logic is to:
collect one or more assistant responses from one or more of the electronic personal assistants which indicate a respective confidence level in one or more of the assistant responses; and
provide a response to the user based on the respective confidence level.

9. A method of coordinating electronic personal assistants, comprising:
sending a request to one or more of at least two electronic personal assistants based on an input from a user;
receiving one or more assistant responses from the one or more electronic personal assistants; and
providing a response to the user based on the collected one or more assistant responses.

10. The method of claim 9, further comprising:
determining if local information is responsive to the input from the user; and
providing the response to the user based on the local information if the local information is determined to be responsive to the input from the user.

11. The method of claim 9, further comprising:
providing information collected from a first electronic personal assistant to a second electronic personal assistant for the second electronic personal assistant to learn from the first electronic personal assistant.

12. The method of claim 9, further comprising:
sending a request to all of the at least two electronic personal assistants based on the input from the user;
receiving assistant responses from all of the at least two electronic personal assistants;
cross-checking the assistant responses; and
determining which electronic personal assistants were able to accurately translate the user input.

13. The method of claim 9, further comprising:
receiving two or more assistant responses;
ranking the two or more assistant responses based on a context; and
providing one of a highest rank assistant response and a rank-ordered list of assistant responses to the user.

14. The method of claim 13, further comprising:
identifying an assistant response selected by the user; and
learning which electronic personal assistant was preferred based on the identified user selection.

15. The method of claim 9, further comprising:
storing one or more categories of information for each of the at least two electronic personal assistants;
determining a current category based on the user input;
comparing the current category against the stored one or more categories of information for each electronic personal assistant; and
sending a request to one or more of the at least two electronic personal assistants based on the comparison.

16. The method of claim 9, further comprising:
receiving one or more assistant responses from one or more of the electronic personal assistants which indicate a respective confidence level in one or more of the assistant responses; and
providing a response to the user based on the respective confidence level.

17. At least one computer readable medium, comprising a set of instructions, which when executed by a computing device, cause the computing device to:
send a request to one or more of at least two electronic personal assistants based on an input from a user;
collect one or more assistant responses from the one or more electronic personal assistants; and
provide a response to the user based on the collected one or more assistant responses.

18. The at least one computer readable medium of claim 17, comprising a further set of instructions, which when executed by the computing device, cause the computing device to:
determine if local information is responsive to the input from the user; and
provide the response to the user based on the local information if the local information is determined to be responsive to the input from the user.

19. The at least one computer readable medium of claim 17, comprising a further set of instructions, which when executed by the computing device, cause the computing device to:
provide information collected from a first electronic personal assistant to a second electronic personal assistant for the second electronic personal assistant to learn from the first electronic personal assistant.

20. The at least one computer readable medium of claim 17, comprising a further set of instructions, which when executed by the computing device, cause the computing device to:
send a request to all of the at least two electronic personal assistants based on the input from the user;
collect assistant responses from all of the at least two electronic personal assistants;
cross-check the assistant responses; and
determine which electronic personal assistants were able to accurately translate the user input.

21. The at least one computer readable medium of claim 17, comprising a further set of instructions, which when executed by the computing device, cause the computing device to:
collect two or more assistant responses;
rank the two or more assistant responses based on a context; and
provide one of a highest rank assistant response and a rank-ordered list of assistant responses to the user.

22. The at least one computer readable medium of claim 21, comprising a further set of instructions, which when executed by the computing device, cause the computing device to:
identify an assistant response selected by the user; and
learn which electronic personal assistant was preferred based on the identified user selection.

23. The at least one computer readable medium of claim 17, comprising a further set of instructions, which when executed by the computing device, cause the computing device to:
store one or more categories of information for each of the at least two electronic personal assistants;
determine a current category based on the user input;
compare the current category against the stored one or more categories of information for each electronic personal assistant; and
send a request to one or more of the at least two electronic personal assistants based on the comparison.

24. The at least one computer readable medium of claim 17, comprising a further set of instructions, which when executed by the computing device, cause the computing device to:
collect one or more assistant responses from one or more of the electronic personal assistants which indicate a respective confidence level in one or more of the assistant responses; and
provide a response to the user based on the respective confidence level.
